(19) United States
(12) Patent Application Publication
(10) Pub. No.: US 2010/0068451 A1
(43) Pub. Date: Mar. 18, 2010

(54) BUILDING PANEL WITH WOOD FACING LAYER AND COMPOSITE SUBSTRATE BACKING LAYER

(76) Inventors: David Richard Graf, South Portsmouth, KY (US); Gregory P. Graf, South Portsmouth, KY (US)

Correspondence Address: KING & SCHICKLI, PLLC, 247 NORTH BROADWAY, LEXINGTON, KY, 40507, US

(21) Appl. No.: 12/561,703

(22) Filed: Sep. 17, 2009

Related U.S. Application Data
(60) Provisional application No. 61/097,634, filed on Sep. 17, 2008.
(60) Provisional application No. 61/146,800, filed on Jan. 23, 2009.

(51) Int. Cl. B32B 21/14; B32B 21/02; B32B 3/06

(52) U.S. Cl. 428/99; 428/535; 428/292.4

(57) ABSTRACT

A building product includes a wood facing layer and a composite substrate backing layer connected to a bottom face of the wood facing layer. Cooperating tongue and groove connectors with locking teeth allow two or more building products to be interconnected in an efficient and effective manner.

This application claims the benefit of U.S. provisional patent application Ser. No. 61/097,634 filed on 17 Sep. 2008 and U.S. provisional patent application Ser. No. 61/146,800 filed on 23 Jan. 2009, the disclosures of which are fully incorporated herein by reference.

### TECHNICAL FIELD

The present invention relates generally to the building supply field and, more particularly, to a building panel incorporating a wood facing layer and a composite substrate backing layer.

### BACKGROUND OF THE INVENTION

Laminated building products, including those useful as flooring are well known in the art. Examples of such products incorporating various interlocking structures are disclosed in, for example, U.S. Pat. No. 6,324,809 to Nelson, U.S. Pat. No. 6,584,747 to Kettler et al., U.S. Pat. No. 7,131,242 to Martensson et al, U.S. Pat. No. 7,137,229 to Pervan, U.S. Pat. No. 7,386,963 to Pervan and U.S. Pat. No. 7,441,385 to Paulson et al.

The present invention relates to a building panel with a new and improved interlocking structure that is simple and easy to connect while providing a more secure and higher integrity connection once installed.

### SUMMARY OF THE INVENTION

In accordance with the purposes of the present invention as described herein, an improved building product is provided comprising a wood facing layer made from wood and a composite substrate backing layer connected to a bottom face of the wood facing layer. The wood facing layer may be made from hardwood selected from a group of hardwoods consisting of Sapele, Santos mahogany, Santos cherry, Brazilian cherry tigerwood, ash, white oak, red oak, walnut, hard maple, American cherry, hickory and mixtures thereof.

The substrate backing layer is made from a composite material including a fiber reinforcement and a matrix binder. The composite material typically includes between about 0 and about 50 weight percent fiber reinforcement and between about 50 and about 100 weight percent matrix binder. The fiber reinforcement is selected from a group of materials consisting of saw dust, plant fiber, cellulose fiber, carbon fiber, glass fiber and combinations thereof. The matrix binder is selected from a group of materials consisting of polyvinyl chloride, polypropylene, high density polyethylene, low density polyethylene, ultra high molecular weight polyethylene, polyester, polycarbonate, ABS and mixtures thereof.

In one particularly useful embodiment the building product includes cooperating connectors provided at adjacent ends of the product. In another useful embodiment the product includes cooperating connectors on adjacent side edges thereof. In either of these embodiments the cooperating connectors comprise a cooperating tongue and groove structure. The tongue includes a face incorporating a series of ridges or teeth and the groove includes a channel having a wall with a series of cooperating ridges or teeth wherein the ridges or teeth on a first building product mesh with the ridges or teeth on a second building product in order to interconnect the building products and form a wall or flooring. In one particularly useful embodiment the ridges are teeth that project between about 0.008 and about 0.014 inches from the face. The tongue projects between about 0.240 and about 0.260 inches from one side edge of the building product and the groove has a depth of between about 0.281 and about 0.301 inches on an opposite side edge of the building product.

For most applications the wood facing layer has a thickness of between about 0.075 and about 0.500 inches while the composite substrate backing layer has a thickness of between about 0.375 and about 0.625 inches. While the building product is useful for a number of applications including the constructing of walls and floors, it is particularly useful as outdoor flooring or indoor flooring.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is a top plan view of a building product constructed in accordance with the teachings of the present invention;

FIG. 2 is an end elevational view illustrating the building product shown in FIG. 1; and

FIG. 3 is an end elevational view illustrating the interconnection of two building products by means of the cooperating connectors provided on those products.

Reference will now be made in detail to the present preferred embodiment of the invention, examples of which are illustrated in the accompanying drawings.

### DETAILED DESCRIPTION OF THE INVENTION

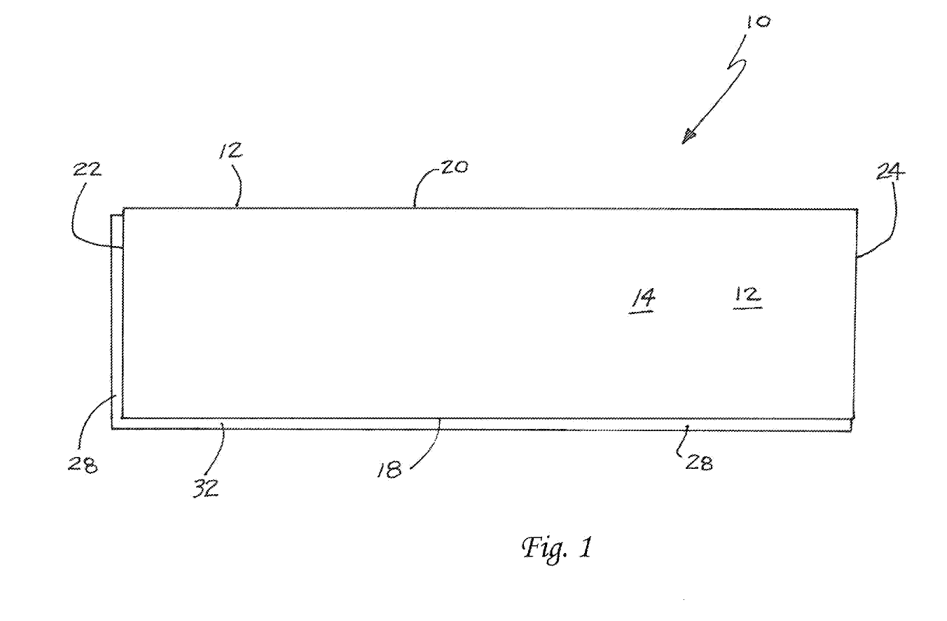

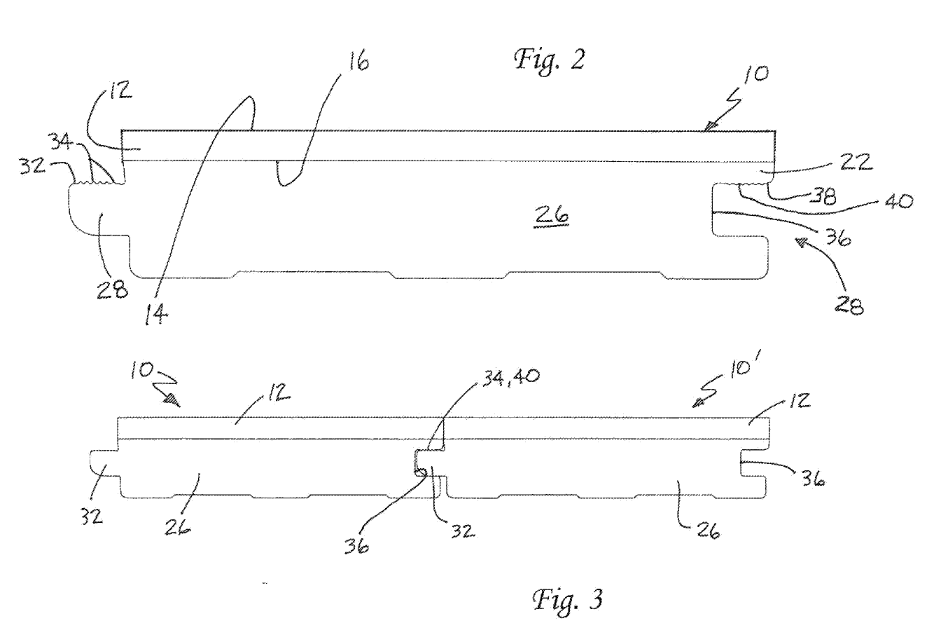

Reference is now made to FIGS. 1 and 2 illustrating the building product 10 of the present invention. The building product 10 is suited for use in a number of different applications including as a wall covering and as a ceiling covering. The building product 10 is particularly useful as an industrial, commercial and residential flooring material.

The building product 10 includes a wood facing layer 12 having a front face 14, a rear face 16, a first side edge 18, a second side edge 20, a first end edge 22 and a second end edge 24. A composite substrate backing layer 26 is connected or laminated to the rear or bottom face 16 of the wood facing layer 12.

The wood facing layer 12 may be made from a hardwood. Suitable hardwoods include, but are not limited to, a group consisting of ash, maple, cherry and oak. Both domestic and imported hardwoods may be utilized. In one particularly useful embodiment, the wood facing layer 12 is made from a single, continuous piece of wood material.

The substrate backing layer may be made from a composite material including a fiber reinforcement and a matrix binder. In one particularly useful embodiment the composite material includes between about 0 and about 50 weight percent fiber reinforcement and between about 50 and about 100 weight percent matrix binder. The fiber reinforcement may, for example, be selected from a group of materials consisting of sawdust, plant fiber, cellulose fiber, carbon fiber, glass fiber and combinations thereof. The matrix binder may, for example, be selected from a group of materials consisting of polyvinyl chloride, polypropylene, high density polyethylene, low density polyethylene, ultra high molecular weight polyethylene, polyester, polycarbonate, ABS and mixtures thereof. The composite substrate material may also include other appropriate additives and fillers such as blowing agents, coloring agents, antibacterial agents, antifungal agents, anti-mold agents and fire retardant agents, calcium carbonate, ammonium hydroxide, tac, mica and other mineral fillers to name just a few of the many possibilities. Advantageously, the composite substrate is suitable for withstanding moisture and warping while also displaying good fire retardant properties. It also is characterized by only nominal expansion and contraction under anticipated environmental conditions.

The building product 10 further includes a tongue 28 provided along the entire length of the first side edge 18 and first end edge 22 and a groove 30 provided along the entire length of the second side edge 20 and second end edge 24. The tongue 28 and groove 30 cooperate to allow adjacent building products 10 to be interconnected. In the illustrated embodiment the tongue 28 includes a face 32 incorporating a series of ridges 34 in the form of slide-in, self-gripping, alligator like teeth. The cooperating groove 30 comprises a channel 36 having a wall 38 including cooperating teeth 40 (note, for purposes of clarity, the teeth 34, 40 are not illustrated in FIG. 1). When the cooperating tongue 28 and groove 30 are interconnected, the ridges or teeth 34, 40 mesh so as to provide a secure connection. Advantageously, this configuration of tongue 28 and groove 30 allows the tongue 28 on one building product 10 to be easily inserted with sliding motion into the groove 30 of another building product 10′ (see FIG. 3) with minimal effort in order to allow the building products to be securely connected together with a tight, gapless joint fit while also allowing easy installation. The meshing of the ridges or teeth 34, 40 also ensures a high integrity connection resistant to slipping or pulling apart at any time during the installation process.

The building product 10 is also easy to produce in a cost effective manner. The composite substrate backing layer 26 may be extruded with the cooperating tongue 28 and groove 30 structures and capped in one process enabling rapid production of the building product 10 in the form of boards, panels or other products for different applications as needed. The extruded substrate backing layer 26 may be affixed to the wood facing layer 12 by heat or sonic welding, adhering with glue or other available techniques. The affixing of the wood facing layer 12 to the composite substrate backing layer 26 may be performed at a manufacturing facility any timer prior to shipment and/or sale of the product. Alternatively, the affixing of the wood facing layer 12 to the composite substrate backing layer 26 may be performed on a job site

In yet another embodiment, in the extrusion process or as a secondary operation, the composite substrate backing layer can be supplied with an insulating material to provide a moisture and/or sound barrier that will improve the thermal and acoustic performance of the building product.

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A building product, comprising:
a wood facing layer made from wood; and
a composite substrate backing layer connected to a bottom face of said wood facing layer.

2. The building product of claim 1, wherein said wood facing layer is made from a hardwood.

3. The building product of claim 2, wherein said hardwood is an imported hardwood.

4. The building product of claim 2, wherein said hardwood is a domestic hardwood.

5. The building product of claim 2, wherein said hardwood is selected from a group consisting of Sapele, Santos mahogany, Santos cherry, Brazilian cherry tigerwood, ash, white oak, red oak, walnut, hard maple, American cherry, hickory and mixtures thereof.

6. The building product of claim 1, wherein said substrate backing layer is made from a composite material including a fiber reinforcement and a matrix binder.

7. The building product of claim 6, wherein said composite material includes between about 0 and about 50 weight percent fiber reinforcement and between about 50 and about 100 weight percent matrix binder.

8. The building product of claim 7, wherein said fiber reinforcement is selected from a group of materials consisting of saw dust, plant fiber, cellulose fiber, carbon fiber, glass fiber and combinations thereof.

9. The building product of claim 8, wherein the matrix binder is selected from a group of materials consisting of polyvinylchloride, polypropylene, high density polyethylene, low density polyethylene, ultra high molecular weight polyethylene, polyester, polycarbonate, ABS and mixtures thereof.

10. The building product of claim 1 used as flooring.

11. The building product of claim 1 wherein said wood facing layer is made from a single, continuous piece of wood.

12. The building product of claim 1 including cooperating connectors provided on opposed ends of said product.

13. The building product of claim 7 including cooperating connectors provided on opposed side edges thereof.

14. The building product of claim 13 wherein said cooperating connectors comprise a tongue and a groove.

15. The building product of claim 14, wherein said tongue includes a face incorporating a series of teeth and said groove includes a channel having a wall with a series of cooperating teeth, wherein said teeth on a first building product mesh with said teeth on a second building product when said first and second building products are connected together.

16. The building product of claim 15 wherein said teeth project between about 0.008 and about 0.014 inches from said face.

17. The building product of claim 16, wherein said tongue projects between about 0.240 and about 0.260 inches from one side edge of said building product and said groove has a depth of between about 0.281 and about 0.301 inches on an opposite side edge of said building product.

18. The building product of claim 17 wherein said wood facing layer has a thickness of between about 0.025 and about 0.500 inches.

19. The building product of claim 19 wherein said composite substrate backing layer has a thickness of between about 0.375 and about 0.625 inches.
